(19) United States
(12) Patent Application Publication
(10) Pub. No.: US 2014/0358425 A1
(43) Pub. Date: Dec. 4, 2014

(54) DELIVERING ROUTE INFORMATION

(71) Applicants: Rohan Seth, San Francisco, CA (US); Joshua J. Sacks, San Carlos, CA (US); Michele Covell, Palo Alto, CA (US); Michael Chu, Los Altos Hills, CA (US); Shumeet Baluja, Leesburg, VA (US); David Marwood, San Francisco, CA (US)

(72) Inventors: Rohan Seth, San Francisco, CA (US); Joshua J. Sacks, San Carlos, CA (US); Michele Covell, Palo Alto, CA (US); Michael Chu, Los Altos Hills, CA (US); Shumeet Baluja, Leesburg, VA (US); David Marwood, San Francisco, CA (US)

(73) Assignee: GOOGLE INC., Mountain View, CA (US)

(21) Appl. No.: 13/117,625

(22) Filed: May 27, 2011

(51) Int. Cl. G01C 21/00

(52) U.S. Cl. 701/438; 701/467

(57) ABSTRACT

Methods, systems, and computer program products are provided for delivering route information. One example method includes receiving a request from a user for a route from a starting point to a destination point, determining the route including route information defining the route, and classifying the route. Prior to the user embarking on the route, one or more content items are determined for presentation to the user based at least in part on the route information and the route classification, and the route information and the content items are delivered to the user responsive to the request.

### BACKGROUND

This specification generally relates to information presentation.

Internet users can provide addresses to map search engines and can receive maps and directions to destinations. Global Positioning System (GPS) devices can include maps, and can provide users with navigation instructions and information related to their current position.

### SUMMARY

In general, one innovative aspect of the subject matter described in this specification may be embodied in methods, systems, and computer program products for delivering route information. One example method includes receiving a request from a user for a route from a starting point to a destination point, determining the route including route information defining the route, and classifying the route. Prior to the user embarking on the route, one or more content items are determined for presentation to the user based at least in part on the route information and the route classification, and the route information and the content items are delivered to the user responsive to the request.

In general, another innovative aspect of the subject matter described in this specification may be embodied in a method that includes receiving a request from a user for directions from a starting point to a destination point, the user request provided from a device that is associated with a location where the location is not the starting point. Directions are determined, and one or more content items are determined for presentation to the user based at least in part on the directions, the starting point, or the destination point. The directions and the content items are delivered to the user responsive to the request.

In general, another innovative aspect of the subject matter described in this specification may be embodied in a computer program product that can perform operations including receiving a request from a user for a route from a starting point to a destination point, determining the route including route information defining the route, and classifying the route. Prior to the user embarking on the route, the computer program product can perform operations including determining one or more content items for presentation to the user based at least in part on the route information and the route classification, and delivering the route information and the content items to the user responsive to the request.

In general, another innovative aspect of the subject matter described in this specification may be embodied in a computer program product that can perform operations including receiving a request from a user for directions from a starting point to a destination point (the user request provided from a device that is associated with a location where the location is not the starting point), determining the directions, determining one or more content items for presentation to the user based at least in part on the directions, the starting point, or the destination point, and delivering the directions and the one or more content items to the user responsive to the request.

In general, another innovative aspect of the subject matter described in this specification may be embodied in route providing systems that include route generators, interests identifiers, route classifiers, and content selectors. A route generator can determine routes including route information defining routes. An interests identifier can identify user interests. A route classifier can classify routes, points along routes, route starting points, or route destination points. A content selector can determine one or more content items for presentation to users based at least in part on route information, user interests, or route classifications.

These and other embodiments may each optionally include none, one or more of the following features. In various examples, the content items can be determined based on interests associated with the user.

Classifying the route can include evaluating one or more predetermined criteria and providing a label for the classification. The criteria can include route attributes. The criteria can include route point attributes. The criteria can include user attributes. The criteria can include at least one of route attributes, route point attributes, or user attributes.

Classifying the route can include classifying the destination point and determining the content items can be based at least in part on the destination point classification. Classifying the route can include classifying the starting point and determining the content items can be based at least in part on the starting point classification. One or more intermediary points along the route can be identified, and classifying the route can include classifying at least one of the intermediary points, and determining the content items can be based at least in part on the intermediary point classification. Classifying the route can include classifying the route as being longer than a predetermined distance and determining the one or more content items can be based at least in part on a length of the route. Classifying the route can include classifying the route as either business or recreational and determining the content items can be based on the classification.

Receiving the request from the user for a route can include receiving a trip purpose description from the user and determining content items for presentation to the user can be based at least in part on the trip purpose description. A selection of one or more route classifications can be received from a provider of the content items and delivering the route information and the content items can include delivering content items based at least in part on the selection. A plurality of routes between the starting point and destination point can be determined and classified, and determining a route for delivery can be based at least in part on the one or more content items that are determined for each route.

Particular embodiments of the subject matter described in this specification may be implemented to realize none, one or more of the following advantages. Content items of interest to users can be provided prior to embarkation to a destination. Content items can be related to points along routes. Routes can be categorized, and content items can be related to route categories.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a diagram of an example system that can deliver route information.

FIG. 2 is a diagram of an example system that can receive route classification selections from content item providers.

FIG. 3 is a flowchart of an example process for delivering route information.

FIG. 4 is a flowchart of an example process for delivering directions.

FIG. 5 shows an example of a computer device and a mobile computer device that can be used to implement the techniques described here.

Like reference symbols in the various drawings indicate like elements.

### DETAILED DESCRIPTION

In general, a system can deliver route information to users prior to embarkation along a route (e.g., at the start of a trip). Upon receiving a route request from a user, for example, the system can determine one or more routes and one or more content items (e.g., text, video, graphics, audio, etc.) for presentation to the user. In some implementations, the system can classify routes, and determining content items can be can be based on route classification and user interests.

The systems discussed here may provide one or more mechanisms for collecting information about users. Users may be provided with an opportunity to opt in/out of programs that may collect personalized information. In addition, certain data may be anonymized in one or more ways before it is stored or used, so that personally identifiable data is removed.

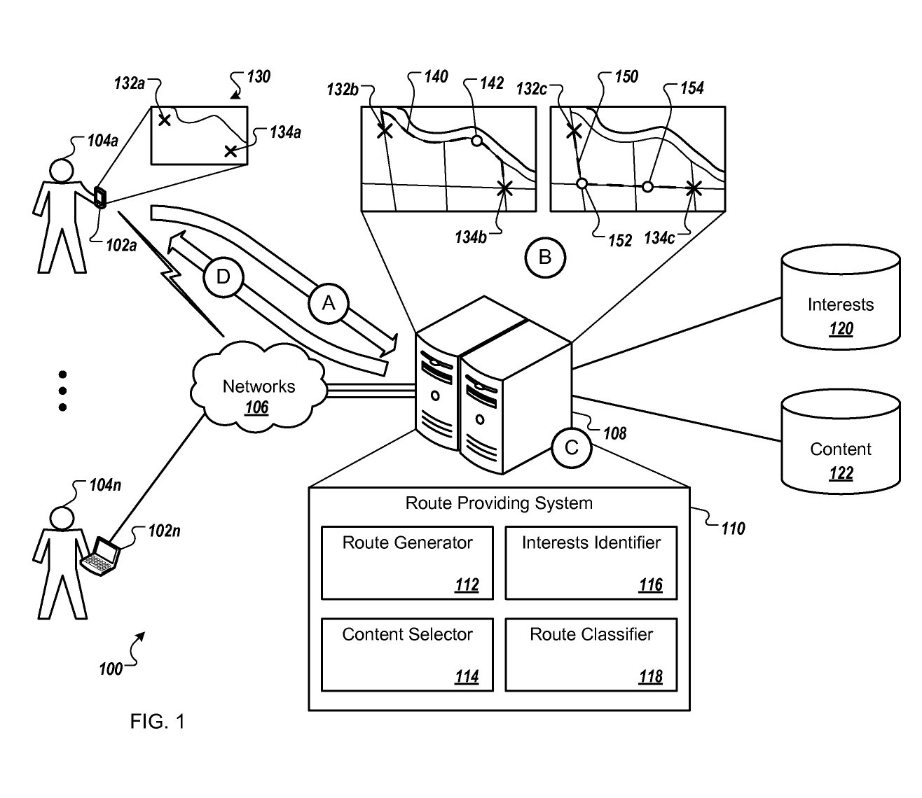

FIG. 1 is a diagram of an example system 100 that can deliver route information. FIG. 1 also illustrates an example flow of data within the system 100 during states (A) to (D), where the states (A) to (D) may occur in the illustrated sequence, or they may occur in a sequence that is different than in the illustrated sequence.

In further detail, the system 100 includes one or more client computing devices 102 (each operated by a user 104) that communicate over one or more networks 106 with one or more computing servers 108. The networks 106 may include a wireless cellular network, a wireless local area network (WLAN) or WiFi network, a Third Generation (3G) or Fourth Generation (4G) mobile telecommunications network, or any other network or any appropriate combination thereof.

The client device(s) 102 may be any suitable type of electronic device (e.g., mobile phone, smart phone, PDA, tablet computer, laptop or desktop computer, or other stationary or portable device) that includes one or more processors and computer readable media. Among other components, for example, the client device(s) 102 includes one or more processors, computer readable media that store software applications, input device(s) (e.g., touch screens, keyboards, computer mice, motion sensors, microphones, and the like), output device(s) (e.g., display screens, speakers, and the like), and communications interfaces.

The computing server(s) 108 may be configured to execute application code associated with a variety of software components (e.g., modules, objects, libraries, services, and the like), including computer instructions to perform some or all of the method steps described below. In some implementations, the computing server(s) 108 may include one or more components of a route providing system 110 for delivering route information to users.

The route providing system 110 can include a route generator 112, a content selector 114, an interests identifier 116, and a route classifier 118. Two or more of the components 112, 114, 116, and 118 may be implemented on the same device (e.g., same computing device), or on different devices, such as devices included in a server farm or a peer-to-peer network. The route providing system 110 and server(s) 108 can be in communication with one or more data storage devices, including an interests data store 120 and a content data store 122. The data stores 120, 122 can implement databases, file systems, or other memory structures to add, remove, and maintain data used by the system 100.

Referring to the example flow of data, during state (A), a route request can be received from a user. For example, the user 104a can employ the client device 102a to access a route providing application 130 (e.g., an application for generating maps or directions). Using the route providing application 130, for example, the user 104a can indicate a starting point 132a and a destination point 134a. For example, the user 104a can provide addresses or place names (e.g., the name of a neighborhood, building, landmark, etc.) for the starting point 132a and destination point 134a. As another example, the user 104a can interact with a map displayed by the route providing application 130 to indicate (e.g., by pointing) the starting point 132a and destination point 134a. Information associated with the points 132a, 134a can be provided by the client device 102a to the route providing system 110 via the network(s) and the computing server(s) 108.

During state (B), the route can be determined, including information defining the route. For example, the route providing system 110 can use the route generator 112 to generate one or more routes 140, 150 from the starting point 132a to the destination point 134a indicated by the user 104a. In the present example, the route 140 (e.g., a route along a coastal road) includes a starting point 132b (corresponding to point 132a) and a destination point 134b (corresponding to point 134a). The route 150 (e.g., a highway route) in the present example includes a starting point 132c (corresponding to point 132a) and a destination point 134c (corresponding to point 134a). Routes can be generated by referencing map representations, for example, and by determining possible paths along and between roads included in the representations. In some implementations, information defining the route may be supplemented with information such as speed limits, construction schedules, weather conditions, and traffic patterns. Thus, routes can be optimized for such factors as distance, time, convenience, and safety, for example.

In some implementations, one or more intermediary points along the route(s) can be identified. For example, the route generator 112 can identify intermediary point 142 along the route 140, and can identify intermediary points 152, 154 along the route 150. Intermediary points, for example, may be associated with providers of goods and services, or other places of interest.

During state (C), one or more content items can be determined. For example, the route providing system 110 can use the content selector 114 to determine content items for presentation to the user 104a based at least in part on the route information. Content items may include content such as text, video, graphics, and audio, for example, and may be provided by the content data store 122.

In some implementations, content items may be determined based on user interests (e.g., activities, hobbies, research areas, etc.). The route providing system 110 can use the interests identifier 116, for example, to identify interests of the user 104a. For example, the user 104a, can use an application executed by the client computing device 102a to directly provide information related to his or her interests. As another example, interests of the user 104a can be inferred by examining web browsing histories or search query logs associated with the user. Processes for collecting information related to user interests may include options allowing users to opt in/out, and may include techniques for maintaining user privacy. For example, user data can be generalized (e.g., based on user demographics) rather than associated with particular users. Encryption and obfuscation techniques can also be used to protect user privacy. Information related to user interests can be stored and provided by the interests data store 120, for example.

In some implementations, content items may be determined based on route classifications. For example, the route providing system 110 can use the route classifier 118 to classify the routes 140, 150. In some implementations, classification may include characterizing routes based on one or more criteria including evaluating the criteria. Criteria can include predetermined criteria associated with route attributes, the attributes of points along routes, and the attributes of users having traveled along and/or having requested information about the routes. Criteria associated with route attributes, for example, may include distances, proximate features, estimated travel times, traffic conditions, construction conditions, and road types (e.g., divided highways, country roads, city streets, etc.). Criteria associated with points (i.e., locations), along routes, for example, may include location functions or uses (e.g., residential, commercial, recreational, etc.), access types (e.g., public vs. private), hours of operation, and user ratings. Criteria associated with users, for example, may include user history (e.g., travel, search, etc.), user profiles, and user interests. Classifying a route can include characterizing the route as being associated with one or more classes of routes. When classifying routes, for example, route attributes, route point attributes, and/or route user attributes can be evaluated in consideration of various criteria, and routes can be associated with one or more classification labels. Routes in their entirety can be considered, as can starting points, destination points, and/or intermediary points of routes, and as can users that travel and/or request information associated with the routes. In some implementations, route classes can relate to information derived from a route request by a user, the history (e.g., travel, search, etc.) of the user, and the history of user requests.

In the present example, the route classifier 118 may determine that the route 140 (including starting point 132b, intermediary point 142, and destination point 134b) primarily follows a coastline, and thus may be classified as a “scenic route”. The route classifier 118 may also determine, for example, that the route 150 (including starting point 132c, intermediary points 152, 154, and destination point 134c) primarily follows highways, and thus may be classified as a “highway route”. Thus, in the present example, content items potentially of interest to user 104a and/or of relevance to route 140 (e.g., the “scenic route”), such as information related to scenic overlooks or historical markers along the route 140, can be selected by the content selector 114 for presentation to the user 104a. As another example, content items potentially of interest to user 104a and/or of relevance to route 150 (e.g., the “highway route”), such as information related to conveniences such as rest stops and fast food restaurants along the route 150, can be selected.

During state (D), route information and content items can be delivered. For example, the route providing system 110 can deliver information associated with the route 140, the route 150, or both, to the client computing device 102a via the network(s) 106 for presentation to the user 104a. Prior to embarkation of the user 104a to the destination 134a, for example, the user can interact with the content items determined by the content selector 114. Thus, content items of potentially of interest to the user 104a can be provided prior to embarkation, assisting the user 104a in trip planning and/or route selection.

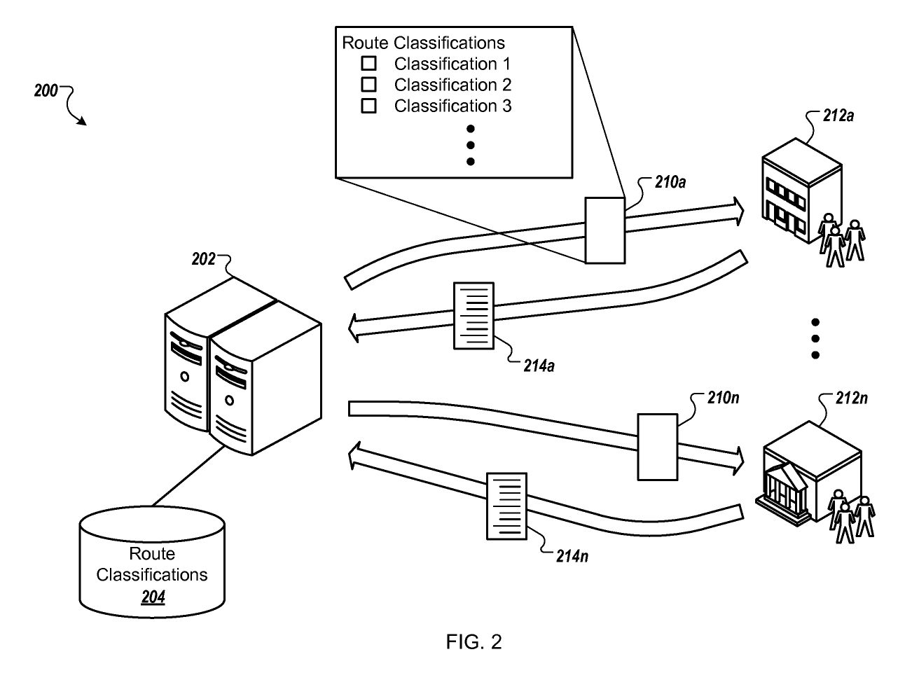

FIG. 2 is a diagram of an example system 200 that can receive route classification selections from content item providers. In some implementations, multiple entities (e.g., organizations, businesses, advertisers) can be provided with information associated with multiple route classifications including selectable classification labels. By selecting route classifications available for targeting, for example, the entities can publish information (e.g., content, recommendations, advertisements) to users embarking on routes matching certain criteria. Targeting for particular classifications can be facilitated by a user interface associated with a campaign origination/management tool (not shown).

In the present example, a route providing system 202 (e.g., similar to the route providing system 110, shown in FIG. 1) can access information associated with classified routes via a route classifications data store 204. The route providing system 202, for example, can provide route classification information 210 to entities 212. For example, route classification information can include labels such as “scenic route”, “highway route”, “family vacation”, “couples vacation”, “long trip”, “short trip”, and the like. The entities 212, for example, can select from the provided route classification labels, and can provide route classification selection information 214 to the route providing system 202.

In some implementations, route classification selection information 214 received from the entities 212 can be used by the route providing system 202 for determining content items for presentation to users responsive to route requests. For example, upon determining that a particular user has requested route information for a route classified by the route classifier 118 (shown in FIG. 1) as a “scenic route”, the route providing system 110 (also shown in FIG. 1) may provide the user with content items associated with one or more entities 212 that have selected the route classification. Thus, in the present example, entities that desire to target content to users traveling along “scenic routes” may do so.

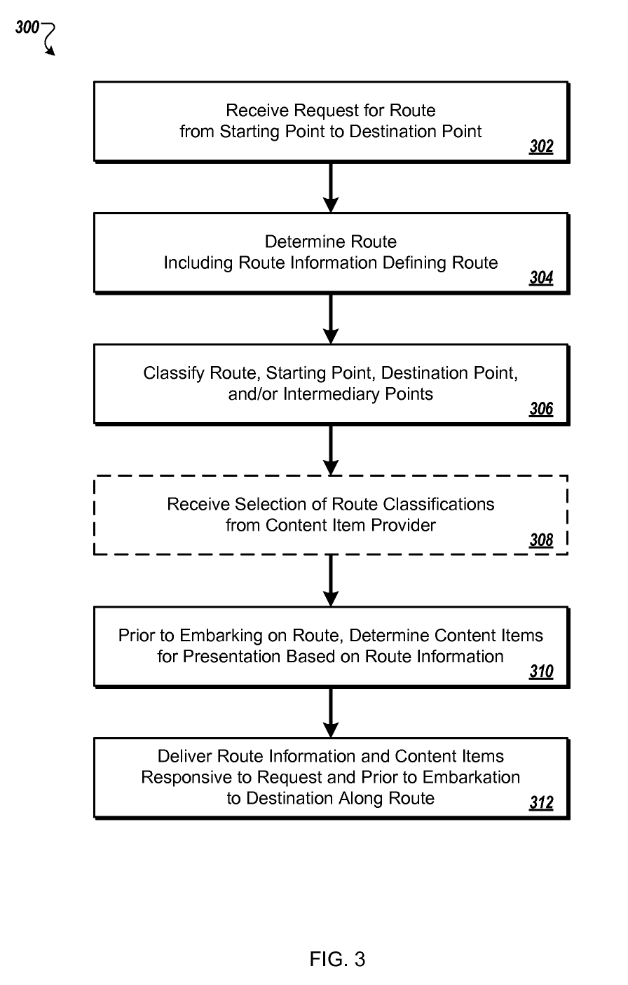

FIG. 3 is a flowchart of an example process 300 for delivering route information. In some implementations, the process 300 may be performed by the system 100 (shown in FIG. 1), and will be described as such for the purpose of clarity. Briefly, the process 300 can include receiving a request for a route from a starting point to a destination point, and determining the route including route information defining the route. The route, starting point, destination point, and/or one or more intermediary points along the route can be classified. Content items for presentation can be determined based on route information, and the route information can be delivered.

A request from a user for a route, for example, from a starting point to a destination point, can be received (302). For example, the user 104a can employ the route providing application 130 executed by the client computing device 102a to request one or more routes including the starting point 132 and the destination point 134. The route request can be received by the route providing system 110, for example, via the network(s) 106. In some implementations, the starting point may be inferred from the current position of the user. For example, Global Positioning System (GPS) capabilities of the client computing device 102a or location identifying capabilities of the network 106 can be used to provide starting point information included in the route request. As another example, information associated with the current position of the user can be directly provided by the user 104a (e.g., via a user interface).

In some implementations, receiving the request for a route from the user may include receiving a trip purpose description. For example, the user 104a can employ the route providing application 130 executed by the client computing device 102a to indicate a trip purpose description such as “this is a scenic trip for me”, “this is a business trip for me”, or another description. The description can be indicated by a user selection, for example, or by text or voice entry by the user.

The route can be determined (304), including route information defining the route. For example, the route generator 112 can determine one or more routes (e.g., routes 140, 150) between the starting point 132 and the destination point 134. Route information, for example, may include navigational information such as route directions and mapping information (e.g., a map or streetview), and may include supplemental route information such as speed limits, construction schedules, weather conditions, and traffic patterns. Such navigational and supplemental route information can be used by the route generator 112 for determining routes and selecting content items for presentation to users, for example, and can be provided to users in association with determined routes.

In some implementations, one or more intermediary points along the route may be identified. For example, the route generator 112 can identify the intermediary point 142 along the route 140, and can identify the intermediary points 150, 154 along the route 150. Intermediary points (e.g., points 142, 152, 154) may be associated with providers of goods and services (e.g., stores, gas stations, banks, restaurants, hotels, entertainment venues, etc.), or other places of interest (e.g., landmarks, parks, recreational areas, tourist destinations, etc.).

The route, the starting point, the destination point, and/or one or more intermediary points can be classified (306). In some implementations, classifying may include evaluating one or more predetermined criteria, including route attributes, route point attributes, and route user attributes, and providing one or more descriptive labels based on the classification. For example, the route classifier 118 can classify the routes 140, 150, the starting point 132, the destination point 134, the intermediary points 142, 152, 154, and/or the user 104a. Classification, for example, may include comparing route information and route request information associated with multiple users 104 for patterns of similarity, and associating the routes with classification labels (e.g., the classification labels provided to the entities 212, as shown in FIG. 2).

In some implementations, starting points may be classified. For example, the starting point 132 may be associated with an area such as a residential area, and the route classifier 118 may classify the point 132 as a “residential neighborhood”. As another example, the starting point 132 may be associated with an area such as an office park, and the route classifier 118 may classify the point 132 as a “business area”.

In some implementations, destination points may be classified. For example, the destination point 134 may be associated with a tourist destination such as an amusement park, and the route classifier 118 may classify the point 134 as a “family recreation” destination. As another example, the destination point 134 may be associated with a shopping destination such as a mall, and the route classifier 118 may classify the point 134 as a “shopping” destination.

In some implementations, intermediary points may be classified. For example, the intermediary points 142, 152, and 154 may be associated with producers of goods and services, or other points of interest. Points associated with restaurants, for example, may be classified by the route classifier 118 as “dining establishments”, for example. As another example, points associated with parks, hiking trails, and camping areas may be classified by the route classifier 118 as “outdoor recreation areas”.

In some implementations, routes may be classified. For example, the route classifier 118 can evaluate one or more portions of a route including the starting point, destination point, and/or intermediary points of a route to classify the route as recreational, business-related, or another such classification. If a particular route includes a starting point classified as a “residential neighborhood” and a destination point classified as a “family recreation” destination, for example, the route may be classified by the route classifier 118 as a “family vacation” route. As another example, if a route includes a starting point classified as a “residential neighborhood”, and a destination point and/or one or more intermediary points classified as “outdoor recreation areas”, the route may be classified as an “outdoors vacation” route.

In some implementations, classifying a route may include classifying the route as being longer than a predetermined distance. For example, the route classifier 118 can evaluate the length of a particular route, and can use the length as a criterion for classification. If the route is shorter than a predetermined distance (e.g., twenty miles, ten miles, five miles, a mile, or another suitable distance), for example, and if the destination point is classified as a “shopping destination”, the route classifier 118 may classify the route as an “errand trip”. As another example, if the route is longer than a predetermined distance, and if the destination point is classified as a “business area”, the route classifier 118 may classify the route as a “business trip”.

Optionally, a targeting selection of one or more route classifications may be received (308) from a provider of one or more content items. For example, referring to FIG. 2, one or more entities 212 can select from provided route classification labels (e.g., included in the route classification information 210), and can provide route classification selection information 214 to the route providing system 202. In some implementations, the entities 212 can also provide content items to be delivered to users embarking on routes associated with the selected classification labels, and content items can be delivered to users based at least in part on the selection. For example, an amusement park can provide content items associated with the park (e.g., contact information, hours of operation, service information, etc.), and can specify that users embarking on routes proximate to the park are to be provided with the content items should their route be classified as a “family vacation”.

Prior to the user embarking on the route, one or more content items for presentation to the user can be determined (310), based at least in part on the route information. For example, the content selector 114 can select one or more content items from the content data store 122 to be provided to the user 104a prior to embarkation of the user. Content items, for example, may include content such as text, video, graphics, and audio content, and may be used to present information associated with various entities. For example, informational content (e.g., contact information, hours of operation, prices, reviews, etc.) related to entities associated with various points (e.g., intermediary points, destination points) along the routes 140, 150 may be determined by the content selector 114. As another example, promotional content such as advertisements and coupons may be determined.

In some implementations, determining the content items may be based at least in part on classification of the route, the starting point, the destination point, and/or one or more of the intermediary points. For example, if the route 140 were to be classified by the route classifier 118 as an “outdoor vacation”, the content selector 114 may select one or more content items associated with outdoor activities, such as hiking and camping. As another example, if the route 140 were to be classified by the route classifier 118 as an “errand trip”, the content selector 114 may select one or more content items potentially relevant to the user 104a while running errands, such as content items associated with banks, gas stations, and convenience stores.

In some implementations, one or more of the content items may be determined based on interests associated with the user. For example, the interests identifier 116 can receive from the interests data store 120 information associated with interests of the user 104a. If the user 104a is determined by the interests identifier 116 to have an interest in fine dining, for example, dining-related content items selected by the content selector 114 may be selected from upscale restaurants. As another example, if the user 104a is identified as having an interest in home improvement, content items associated with entities such as hardware stores may be selected by the content selector 114 for a route classified by the route classifier 118 as an “errand trip”.

In some implementations, one or more of the content items may be determined based at least in part on a trip purpose description provided by the user. For example, if the user 104a indicates that the trip is intended to be a “scenic trip”, the content selector 114 may select one or more content items related to sightseeing activities or destinations. As another example, if the user 104a indicates that the trip is intended to be “business trip”, the content selector 114 may select one or more content items related to business-related activities or conveniences.

In some implementations, determining content items may be based at least in part on length of the route. For example, for a short route (e.g., an “errand trip”), content items selected by the content selector 114 may be related to convenience and service. As another example, for a long trip (e.g., a trip classified as a “vacation”), content items associated with dining and sleeping accommodations may be selected by the content selector 114. If the time of day at which the user 104a embarks on a route is known or can be determined, for example, the content selector 114 may select content items associated with dining establishments along the route that the user 104a will pass at meal times, and may select content items associated with sleeping accommodations along the route that the user 104a will reach at the end of a day of driving.

The route information and the one or more content items can be delivered (312) to the user responsive to the request. For example, prior to embarkation of the user 104a to the destination point 134, the route providing system 110 can provide route information and content item information via the network(s) 106 to the client computing device 102a for presentation to the user 104a.

In some implementations, a plurality of routes can be determined, and determining a route for delivery may be based in part on the one or more content items that are determined for each route. For example, the route generator 112 can generate multiple routes (e.g., routes 140, 150), the route classifier 118 can classify each of the routes, and the content selector 114 can select content items for each. In the present example, the route providing system 110 can determine one or more of the routes 140, 150 for delivery to the user 104a based at least in part on the selected content items. For example, if the routes 140, 150 are determined to be approximately equal in distance and/or travel time, but the route 140 is associated with one or more content items potentially of greater interest (e.g., as determined by the interests identifier 116) to the user 104a, information and content items associated with the route 140 may be delivered to the user 104a.

In some implementations, determining a route for delivery may be based in part on a trip purpose description provided by the user. For example, if the user 104a indicates that the trip is intended to be a “scenic trip”, a route classified by the route classifier 118 as “scenic” can be provided to the user 104a. As another example, routes can be modified based on the determined content items. If the user 104a has indicated a desire to embark on a “scenic trip”, for example, the route generator 112 can generate or modify a route to pass by destinations associated with content items that may be of interest to the user 104a.

By providing content information in association with route information, for example, users can be provided with useful information while traveling. In addition, by classifying routes and providing content based at least in part on the classifications, route characteristics can be considered when selecting content.

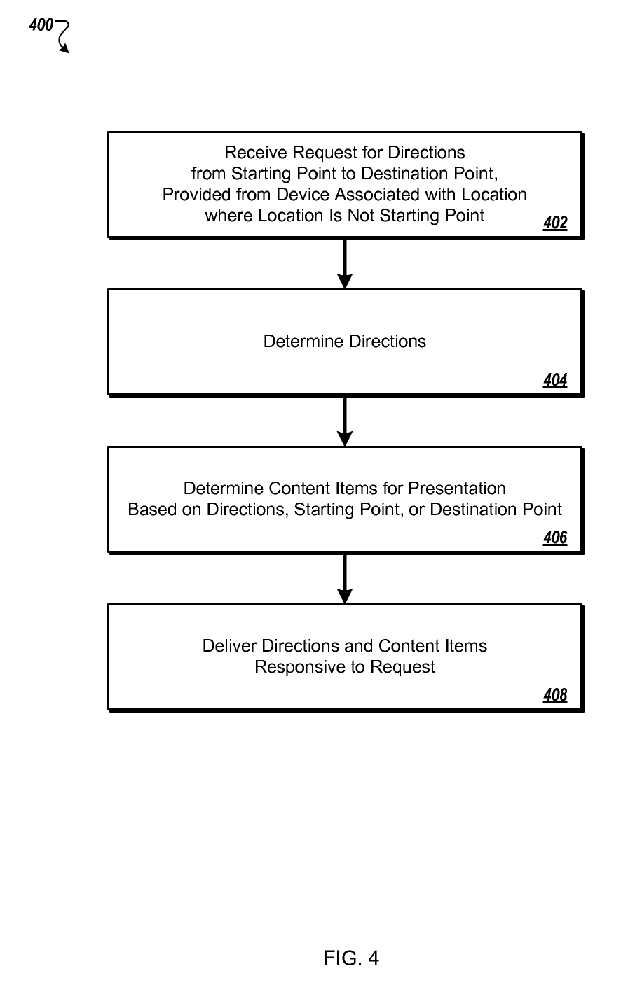

FIG. 4 is a flowchart of an example process 400 for delivering directions. In some implementations, the process 400 may be performed by the system 100 (shown in FIG. 1), and will be described as such for the purpose of clarity. Briefly, the process 400 can include receiving a request for directions from a starting point to a destination point, provided from a device associated with a location where the location is not the starting point. Directions can be determined, as can content items for presentation, based on the directions, starting point, and/or destination point. Directions and content items can be delivered, responsive to the request.

A request from a user can be received (402) for directions from a starting point to a destination point, the request provided from a device that is associated with a location where the location is not the starting point. For example, the user 104a can employ an application executed by the client computing device 102a to request one or more routes including the starting point 132 and the destination point 134. In the present example, the location of the device 102a (and the user 104a) is not the same as the starting point 132. For example, the user 104a may use the device 102a to perform research for various travel options in advance of a trip. The route request can be received by the route providing system 110, for example, via the network(s) 106.

The directions can be determined (404). For example, the route generator can generate step-by-step directions for one or more routes from the starting point 132 to the destination point 134. Directions, for example, may include navigational directions such as street names, place names, turning directions, distances, and times. Supplemental information such as speed limits, construction schedules, weather conditions, and traffic patterns may also be included.

One or more content items for presentation to the user can be determined (406), based at least in part on the directions, the starting point, or the destination point. For example, the content selector 114 can select one or more content items from the content data store 122 to be provided to the user 104a. Content items, for example, may include content such as text, video, graphics, and audio content, and may be used to present information associated with various entities. As described above, the selection of content items can be based at least in part on a classification of the direction information, the starting point, the destination point, and/or intermediary points, the length of the associated trip, the interests of the user, available content items or a combination of one or more of these.

The directions and the content items can be delivered (408) to the user, responsive to the request. For example, the route providing system 110 can provide direction information and content item information via the network(s) 106 to the client computing device 102a for presentation to the user 104a. The user 104a can interact with the directions to navigate to the destination point 134, for example, and can interact with the content item information to locate potential points of interest along the route the destination point.

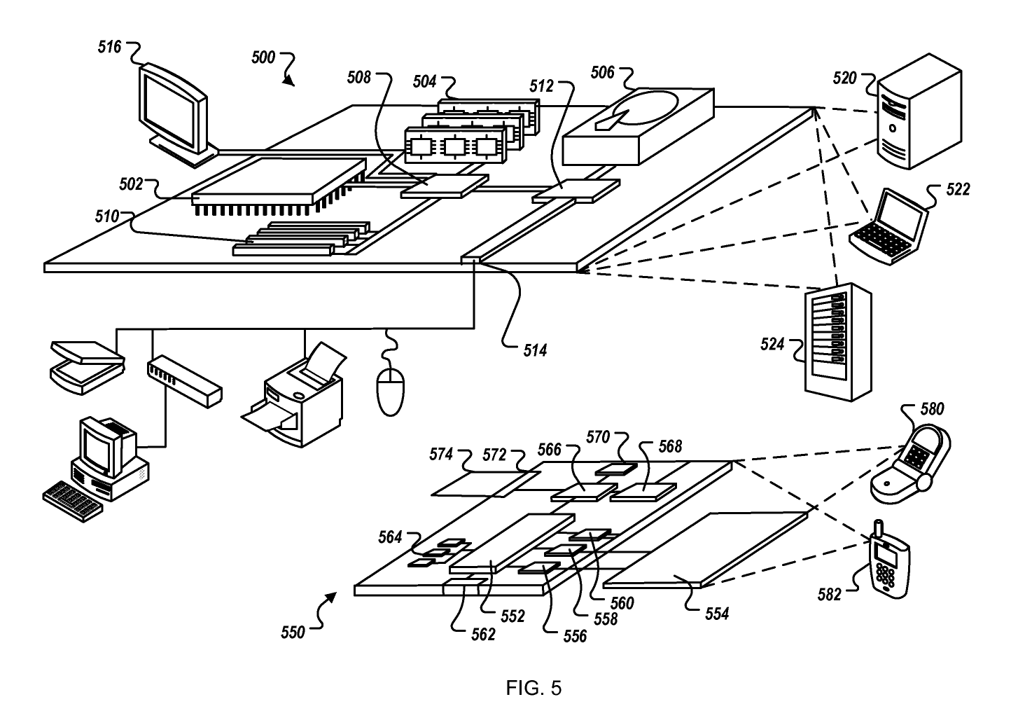

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving, using one or more processor-based devices, a request from a user for a route from a starting point to a destination point;
determining, using the one or more processor-based devices, the route including route information defining the route, the route including the starting point, the destination point and one or more intermediary points, wherein the starting point, the destination point and one or more intermediary points are distinct from one another;
classifying, using the one or more processor-based devices, the route at least in part based on a classification of the starting point, the one or more intermediary points and the destination point, wherein classifying the route includes classifying the route as either business or recreational;
prior to embarking on the route, determining one or more content items for presentation to the user based at least in part on the route information and the route classification; and
delivering the route information and the one or more content items to the user responsive to the request and prior to embarkation of the user to the destination along the route.

2. The method of claim 1 where the one or more content items are determined based on interests associated with the user.

3. The method of claim 1 further comprising classifying the destination point and where determining the one or more content items is based at least in part on classifying the destination point.

4. The method of claim 1 further comprising classifying the starting point and where determining the one or more content items is based at least in part on classifying the starting point.

5. The method of claim 1 further comprising identifying the one or more intermediary points along the route, and classifying at least one of the one or more intermediary points, and where determining the one or more content items is based at least in part on classifying at least one of the one or more intermediary points.

6. The method of claim 1 where the one or more criteria further include a length of the route and where determining the one or more content items is based at least in part on the length of the route.

7. The method of claim 1 where receiving the request from the user for a route includes receiving a trip purpose description from the user and where determining one or more content items for presentation to the user is based at least in part on the trip purpose description.

8. The method of claim 1 further comprising receiving from a provider of the one or more content items a selection of one or more route classifications and where delivering the route information and the one or more content items includes delivering content items based at least in part on the selection.

9. The method of claim 1 further comprising determining a plurality of routes between the starting point and destination point and classifying each of the plurality of routes, and where determining a route for delivery is based at least in part on the one or more content items that are determined for each route.

10. (canceled)

11. The method of claim 1 where classifying the route includes evaluating the one or more criteria and providing a label for the classification.

12. The method of claim 11 where the one or more criteria include route attributes.

13. The method of claim 11 where the one or more criteria include route point attributes.

14. The method of claim 11 where the one or more criteria include user attributes.

15. The method of claim 11 where the one or more criteria include at least one of route attributes, route point attributes, or user attributes.

16. A computer-implemented method comprising:
receiving, using one or more processor-based devices, a request from a user for directions from a starting point to a destination point defining a route, the user request provided from a device that is associated with a location where the location is not the starting point;
determining, using the one or more processor-based devices, the directions;
determining, using the one or more processor-based devices, one or more content items for presentation to the user based at least in part on the directions, and a classification of the route, wherein the classification of the route comprises evaluating one or more criteria including the classification of the starting point, one or more intermediate points along the route and the destination point and providing a label for the classification of the route, wherein the starting point, the one or more intermediate points and the destination point are distinct from one another; and
delivering, using the one or more processor-based devices, the directions and the one or more content items to the user responsive to the request.

17. A system comprising:
a route providing system, implemented using one or more processor-based devices, for delivering route information and content items to users, the route providing system including a route generator, an interests identifier, a route classifier, and a content selector;
where the route generator is enabled to determine routes including route information defining routes;
where the interests identifier is enabled to identify user interests;
where the route classifier is enabled to classify one or more of routes, points along routes, route starting points, or route destination points according to one or more criteria, wherein classifying one or more of routes, points along routes, route starting points, or route destination points according to one or more criteria comprises evaluating the one or more criteria and providing a classification label based on the evaluating, wherein classifying each of the routes is at least in part based on classifying the route start point, route destination point and one or more points along the route, wherein the route start point, route destination point and one or more points along the route are distinct from one another; and
where the content selector is enabled to determine one or more content items for presentation to users based at least in part on route classification.

18. A non-transitory computer-readable storage device storing computer program instructions that when executed by a data processing apparatus cause the data processing apparatus to perform operations comprising:
receiving a request from a user for a route from a start point to a destination point;
determining the route including route information defining the route;
classifying the start point, one or more intermediate points, and destination point, wherein the start point, the one or more intermediate points and the destination point are distinct from one another;
classifying the route based on the classification of the start point, the one or more intermediate points, and the destination point, wherein classifying the route includes evaluating one or more criteria including the classification of the start point, the one or more intermediate points, and the destination point and providing a label for the classification of the route;
prior to embarking on the route, determining one or more content items for presentation to the user based at least in part on the route information and the route classification; and
delivering the route information and the one or more content items to the user responsive to the request and prior to embarkation of the user to the destination along the route.

19. A non-transitory computer-readable storage device storing computer program instructions that when executed by a data processing apparatus cause the data processing apparatus to perform operations comprising:
receiving a request from a user for directions for a route from a start point to a destination point, the user request provided from a device that is associated with a location where the location is not the start point;
determining the directions;
determining one or more content items for presentation to the user based at least in part on the directions, and a classification generated based on classification of the start point, and the destination point and at least one intermediate point along the route, where the classification of the start point, the at least one intermediate point and the destination point includes evaluating one or more criteria and providing a label for the classification, wherein the start point, the intermediate point, and the destination point are distinct from one another; and
delivering the directions and the one or more content items to the user responsive to the request at the user device that is associated with a location that is not the start point.

20. The system of claim 17, where the content selector is further enabled to determine one or more content items for presentation to users based at least in part on one or more of route information, or user interests.
